(19) United States
(12) Patent Application Publication
(10) Pub. No.: US 2013/0003541 A1
(43) Pub. Date: Jan. 3, 2013

(54) Mobile Communications Device and Method

(75) Inventor: Robert Zakrzewski, Bristol (GB)

(73) Assignee: INTELLECTUAL VENTURES HOLDING 81 LLC, Las Vegas, NV (US)

(21) Appl. No.: 13/538,483

(22) Filed: Jun. 29, 2012

(30) Foreign Application Priority Data
Jul. 1, 2011 (GB) 1111267.9

(51) Int. Cl. H04W 28/08

(52) U.S. Cl. 370/230

(57) ABSTRACT

Methods and mobile communications devices to communicate data packets via a mobile communications network, the mobile communications network including a radio network part which includes base stations providing different radio access interfaces from which different radio access bearer types can be formed for communicating the data packets from the mobile communications devices, and a core network part which includes infrastructure equipment for communicating the data packets from the radio network part, the mobile communications device including a radio bearer controller configured to determine a traffic profile of the data packets to be communicated via the mobile communications network from one of a predetermined set of possible traffic profiles, and to select one of the different radio access types to provide a radio access bearer of a type most suitable for communicating the data packets from the mobile communications device in accordance with the determined traffic profile of the data packets.

### FIELD OF THE INVENTION

The present invention relates to mobile communications devices for communicating data packets to or receiving data packets via a mobile communications network and methods for communicating data packets.

### BACKGROUND OF THE INVENTION

Mobile communication systems have evolved over the past ten years or so from the GSM System (Global System for Mobiles) to the 3G system and now include packet data communications as well as circuit switched communications. The third generation partnership project (3GPP) is now developing fourth generation mobile communication systems referred to as Long Term Evolution (LTE) in which a core network part has been evolved to form a more simplified architecture based on a merging of components of earlier mobile communications network architectures and a radio access interface which is based on Orthogonal Frequency Division Multiplexing (OFDM) on the downlink and Single Carrier Frequency Division Multiple Access (SC-FDMA) on the uplink. The core network components are arranged to communicate data packets in accordance with an enhanced packet communications system. As with other mobile communications systems, since the evolution of the second generation GSM system, which only provided voice, basic data services and simple messaging using the Short Message Service LTE systems have been developed to support more sophisticated services.

For example, with the improved radio interface and enhanced data rates provided by LTE systems, a user is able to enjoy high data rate applications such as mobile video streaming and mobile video conferencing that would previously only have been available via a fixed line data connection. Third and fourth generation mobile communication networks therefore typically employ advanced data modulation techniques on the radio interface which cart require more complex and expensive radio transceivers to implement. However not all communications are of a nature which requires the full bandwidth capability of for example the LTE system.

Conventionally an LTE network would be expected to provide communication services to mobile devices such as smart-phones and personal computers (e.g. laptops, tablets and so on). These types of communication services are typically provided with high performance dedicated data connections optimised for high bandwidth applications such as streaming video data. However, recent developments in the field of machine type communication (MTC) (sometimes referred to as machine to machine (M2M) communication) have resulted in more diverse applications being developed to take advantage of the increasing ubiquity of mobile telecommunication networks. As such it is increasingly likely that an LTE network will also be expected to support communication services for simpler network devices such as smart meters, smart sensors or even more simple devices which do not require sophisticated communications such as e-book readers. Devices such as these, generally classified as “MTC devices”, are typically more simple in design than conventional mobile communication devices such as smart-phones and personal computers and are characterised by transmissions of relatively low quantities of data at relatively infrequent intervals. Accordingly, it may be more appropriate to adopt techniques which can make efficient use of communications resources when communicating data in accordance with characteristics of the data to be communicated.

### SUMMARY OF THE INVENTION

According to the present invention there is provided a mobile communications device configured to communicate data packets via a mobile communications network. The mobile communications network comprises a radio network part which includes a plurality of base stations providing a plurality of different radio access interfaces from which a plurality of different radio access bearer types can be formed for communicating the data packets from the mobile communications devices, and a core network part which includes a plurality of infrastructure equipment for communicating the data packets from the radio network part. The mobile communications device includes a radio bearer controller which is configured to determine a traffic profile of the data packets to be communicated via the mobile communications network from one of a predetermined set of possible traffic profiles, and to select one of the plurality of different radio access types to provide a radio access bearer of a type most suitable for communicating the data packets from the mobile communications device in accordance with the determined traffic profile of the data packets.

It has been proposed, for example within the 3GPP to provide a radio access network of a mobile communications system which provides a heterogeneous arrangement of radio access interface types, which allows for example GSM based systems, UMTS and LTE to coexist together. A mobile communications device which is typically multimodal can communicate via different radio access interface types, by attaching to one of a plurality of systems providing one of the radio access interfaces based on direction given by the network. The direction given by the network is not based on properties of traffic or on historical data. Such information about traffic type is usually used for load balancing purposes. The mobile communications devices are seen as registered with each of these radio access systems despite the fact that it is camped on to only one system. Typically, when down link (DL) data has arrived for communication to a mobile device, the mobile is in the IDLE mode. The network proceeds to trigger paging immediately in all of the radio access systems with which the mobile communications device is registered. Typically the only differentiation between traffic types which has been proposed is with respect to circuit switched data (voice) when the circuit switched fallback feature is used, in that the mobile is told to use GSM/UMTS when it is currently camped on the LTE system which does not support circuit switched voice services.

Embodiments of the present invention can provide an arrangement in which a bearer controller within an infrastructure equipment of the core network part of a mobile communications network is configured to identify data packets which are to be communicated to a mobile communications device and to analyse these packets to identify a traffic profile in respect of these data packets to be communicated to the mobile communications device. The bearer controller therefore analyses in one example a rate of arrival of the data packets in order to characterise a communication profile of the data packets with respect to one of a plurality of different traffic profiles by matching a relative rate of arrival of the data packets to predetermined values. In one example a number of data packets arriving within a predetermined period is compared to a plurality of thresholds, and if the number exceeds one threshold but is less than a further threshold the communication of data packets to the mobile communications device from that source can be mapped onto a corresponding traffic profile. In other examples a statistical analysis may be performed for example identifying a mean time between receipt of data packets and a standard deviation of that mean time. The controller is then arranged to identify a most appropriate communications bearer for communicating the data packets to a mobile communications device.

In one example the bearer controller forms part of an infrastructure equipment within for example a serving gateway of a Long Term Evolution architecture, which selects one of a plurality of different radio bearer types for communicating the data packets to the mobile communications device based on the traffic profile. For example the bearer controller may determine that the data packets should be communicated via an LTE network, a GPRS network or indeed, if the bearer controller forms part of a packet data network gateway, a WiFi network.

In another example the bearer controller forms part of an infrastructure equipment of the core network and is configured to determine a type of communications bearer for communicating the data packets via the core network. For example the bearer controller may form part of a packet data gateway and by analysing the arrival of the data packets for communication to a mobile communications device selects a particular bearer providing a predetermined quality of service to communicate the data packets as efficiently as possible via the core network to the radio network part.

In another example the mobile communications device includes a bearer controller which is configured to analyse the generation of data packets for communication from the mobile communications device to a destination address via a mobile communications network and to select a particular radio access bearer type dependent on matching the traffic profile of the generated data packets to one of a predetermined plurality of different traffic profile types.

Thus according to another aspect of the present invention there is provided a mobile communications device which is configured to communicate data packets via a mobile communications network. The mobile communications network comprises a radio network part which includes a plurality of base stations for communicating the data packets via a plurality of different radio access interfaces providing different radio access bearer types for communicating the data packets from the mobile communications devices, and a core network part which includes a plurality of infrastructure equipment for communicating the data packets from the radio network part. The mobile communications device includes a radio bearer controller which is configured to determine a traffic profile of the data packets to be communicated via the mobile communications network from one of a predetermined set of possible traffic profiles, and to select one of the plurality of different radio access interfaces to provide a radio access bearer of a type most suitable for communicating the data packets from the mobile communications device in accordance with the determined traffic profile of the data packets.

Embodiments of the present invention find application with mobile communications networks in which a radio network part provides a variety of radio access interface types, which can communicate both large volumes of data or small volumes of data in a connection less manner but each has different properties making them more suited for delivery of some categories of data rather than others. Example of different radio access interfaces include for example LTE-M, GSM, UMTS, LTE, LTE-A.

Further example aspects and features of the present invention are defined in the appended claims and include a mobile communications device, an infrastructure equipment and methods of operating a mobile communications device infrastructure equipment and mobile communications network.

### BRIEF DESCRIPTION OF THE DRAWINGS

Example embodiments of the present invention will now be described with reference to the accompanying drawings in which like parts have the same designated references and in which:

FIG. 1 is a schematic block diagram of a mobile communications network providing a heterogeneous arrangement of radio access bearers of which the present inventions finds application;

FIG. 2 is schematic block diagram illustrating the operation of a bearer controller within a serving gateway of the mobile communications network showing in FIG. 1;

FIG. 3 is a part schematic block diagram, part flow diagram illustrating the operation of the bearer controller shown in FIG. 2 in accordance with the present technique;

FIG. 4 is a schematic block diagram illustrating an arrangement in which the mobile communications device shown in FIG. 1 changes from an idle to a connected state after receiving a paging message from a base station of the mobile communications network shown in FIG. 1;

FIGS. 5a and 5b provide a flow diagram illustrating the operation of the bearer controller within the packet data network gateway to select a suitable radio bearer for communicating the data packets to the mobile communications device;

FIG. 6 is a schematic block diagram illustrating the operation of a bearer controller within a packet data network gateway communicating data packets via one of a possible plurality of bearer types;

FIG. 7 is a part graphic, part flow diagram illustrating one possible arrangement for identifying a traffic profile from one of a set of possible traffic profiles to which data packets for communication to a mobile communications device may correspond;

FIG. 8 is a schematic block diagram of a mobile communications device adapted in accordance with the present technique;

FIG. 9 is schematic block diagram of a bearer controller forming part of the mobile communications device shown in FIG. 8;

FIGS. 10a and 10b are a flow diagram illustrating the operation of the mobile communications device shown in FIG. 8 to communicate data packets via a radio access bearer determined by the bearer controller within the mobile communications device in accordance with the present technique; and

FIG. 11 is a schematic block diagram providing a further more detailed example operation of the mobile communications device in selecting a radio access bearer for communicating data packets from a mobile communications device to a destination in accordance with the present technique.

### DESCRIPTION OF EXAMPLE EMBODIMENTS

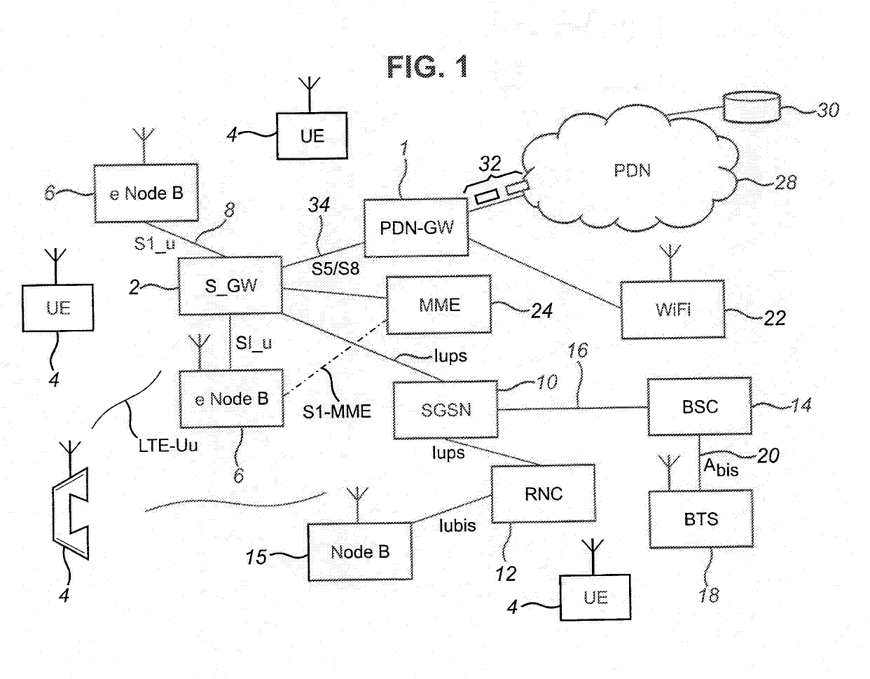

An example of a mobile communications network with which the embodiments of the present invention find application is illustrated in FIG. 1. In FIG. 1 a mobile communications network includes core network components comprising a packet data network (PDN) gateway 1 and one or more serving gateways 2. In FIG. 1 for this illustrative explanation only one serving gateway 2 is shown. The mobile communications network also includes a radio network part formed by what are generally referred to as “base stations”. Different types of base stations are shown as will be explained as follows. The radio network part of the mobile communications network shown in FIG. 1 operates broadly in accordance with the Long Term Evolution (LTE) standard and includes base stations operating to provide radio access communications in accordance with different radio access interface standards. Accordingly radio access bearers of different types are available to communicate the data packets to and/or from the mobile communications devices 4. Thus for the example shown in FIG. 1 the serving gateway 2 is connected to two eNodeBs 6 which are base stations which operate in accordance with the enhanced LTE standard. Thus an interface between the serving gateway 2 and the eNodeBs 6 is via an S1 interface 8. Also connected to the serving gateway 2 is a serving gateway support node (SGSN) 10 which in combination with a radio network controller 12 and NodeB 15 operate in accordance with the 3G/UMTS or GPRS standard for example providing a radio access interface in accordance with W-CDMA or TD-CDMA. Furthermore the SGSN 10 is connected to a base station controller 14 via an Iups interface 16 and to a base transceiver station 18 via an Abis interface 20 which operate in accordance with a 2G or GSM standard.

As will be appreciated from the description of each of the different types of base station 6, 15, 18 and corresponding infrastructure equipment which are required to operate the respect base stations 6, 15, 18 the radio network part of the mobile communications network shown in FIG. 1 can provide a plurality of different radio access bearer types and so it can be said to be a heterogeneous radio access network. According to a conventional definition of some radio access standards, the radio network controller 12, as well as the NodeB 15 and the BSC 12 also form part of the radio access network.

Another sort of base station which may be relevant to the present technique is a WiFi base station or access gateway 22. However the WiFi base station 22 is connected to the PDN gateway 1 and therefore would receive data packets for communication to a mobile communications device 4 from the PDN gateway 1 rather than via the serving gateway 2.

In accordance with the present technique data packets are received by the mobile communications network from a server 30 for communication to one of the mobile communication devices 4, via a packet data network 28. As shown in FIG. 1 the data packets 32 are received at the PDN gateway 1 which communicates the data packets via an S5-S8 interface 34 to a serving gateway 2. The serving gateway 2 conventionally arranges for the data packets to be communicated to the mobile communications device 4 to which the data packets are addressed via a radio access bearer. Conventionally the LTE network architectures also include a mobility management entity MME 24, which is connected to the eNodeBs 6 and the serving gateway2 and is responsible amongst other things for triggering and co-ordinating paging of the mobile communications devices 4.

Conventionally the radio access bearer is established during call setup perhaps via a packet data context application request routine. After a connection has been established the mobile communications device moves to an IDLE state if there is no data packets to transmit or receive. If the serving gateway forms a down-link integration node, the serving gateway conventionally buffers the down link data and immediately triggers paging in all systems with which the mobile communications device is registered. This might be sub-optimal.

In contrast according to the present technique one or both of the packet data gateway 1 or the serving gateway 2 may be arranged to analyse the received data packets to identify data packets which are to be communicated to a particular mobile communications device 4 and to identify a traffic profile of the data packets which have been generated for a particular mobile communications device. The traffic profile is determined by matching observed characteristics of the data packets with respect to one of a predetermined plurality of different characteristics so that the selection of the communications bearer can match the traffic characteristics.

If a bearer controller is included within the packet data gateway 1 then the packet data gateway 1 can be arranged to select one of a plurality of different bearer types, each having a different predetermined quality of service (QoS) for communicating the data packets in accordance with the traffic profile.

If the serving gateway 2 includes a bearer controller, then the bearer controller would be arranged to select a radio access bearer in accordance with the available different types of radio access bearer provided by the different wireless communication standards which are available from the different types of base stations 6, 15, 18.

There are numerous applications which generate small packets of data, which require relatively infrequent transmission on a regular or non regular basis. For example some applications generate and send periodic information once a connection has been established, irrespective of whether the client-server-client model or client peer-to-peer mode is used. The application servers for machine type communications (MTC) may also generate requests and send data packets in a manner which can be described by different traffic profiles. Data packets generated with some traffic profiles can be communicated more efficiently by one radio access interface type or may require a particular radio access system to be used to ensure communications resources are used in an efficient manner. The packet data traffic can be generated periodically by the mobile communications devices 4 or by the server 30. Some applications such as Tweeter, Skype and other typically implement a so called “heart beat” signalling to ensure that the device is still connected. This can be mobile or network initiated. The network initiated communication may also be triggered in the scenarios which require handling/receiving of data which for example provide triggers to initiate measurements to be taken. Alternatively the mobile device may also trigger sending of these reports, for example the measurements of radiation levels. A network initiated communication has an advantage that the network decides when the report should be retrieved, whereas a mobile initiated communication is more autonomous reducing an amount of signalling, which the network needs to undertake to contact the mobile device.

Web browsing can also generate small amounts of data which can create a traffic profile which is hard to characterise by means other than by examining a pattern of generated data packets. Twitter feeds can typically generate small packets traffic, email clients checking periodically mail servers for new emails will typically generate periodic, traffic and the system based on the response of the server will be able to decide whether the system optimized for small data transmissions needs to be used (e.g. if no new emails are present and just the confirmation is sent) or the system offering higher capacity can be used to retrieve the data.

Example implementations of a bearer controller configured in accordance with different example embodiments will be explained below starting for example with a radio bearer controller which forms part of the serving gateway 2.

### Serving Gateway

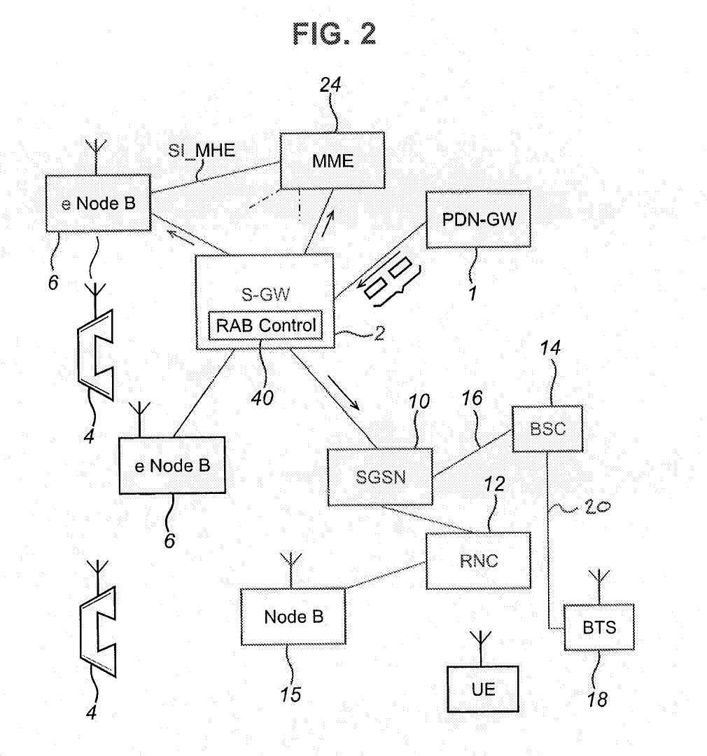

FIG. 2 provides an illustrative representation of the parts of the mobile communications device shown in FIG. 1 which are adapted to select a radio access bearer of a type based on an analysed traffic profile. Further explanation of techniques for analysing the characteristics of data packets for communication into one of a plurality of different predefined types will he explained below.

In FIG. 2 the serving gateway 2 of FIG. 1 is shown with the different types of base stations for providing different radio access interfaces. In accordance with the present technique data packets for communication to a mobile communications device 4 are received at the serving gateway 2. A radio bearer controller 40 within the serving gateway 2 is configured to analyse the data packets to match the characteristics of the communication of the data packets to one of a plurality of different traffic profiles. Once the traffic profile has been identified the radio bearer controller 40 selects an appropriate radio access bearer for communicating the data packets to the mobile communications device 4. Depending on the radio access bearer selected to match the traffic profile, the data packets are routed to one of the base stations 6, 15, 18 which operate in accordance with different radio access standards to provide the different radio bearer types.

Once the radio bearer controller 40 has determined the suitable radio access bearer type, the mobile communications device is paged with an indication of a preferred radio access hearer which should be used for the communication of the data packets to the mobile communications device.

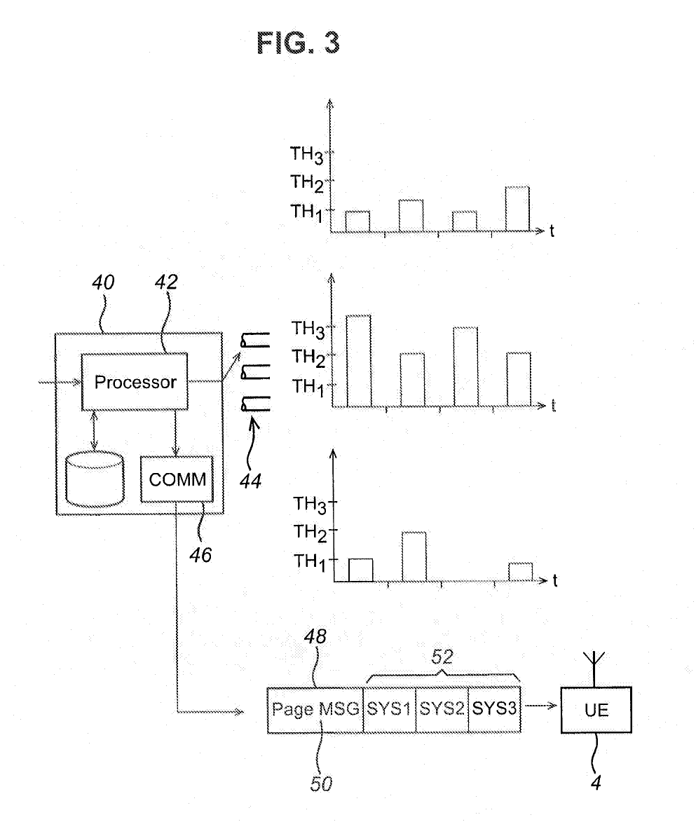

An example illustration of the operation of the radio hearer controller 40 shown in FIG. 2 is shown in more detail in FIG. 3. As shown in FIG. 3 data packets are received by a processor 42 which analyses the data packets to identify a corresponding traffic profile type for the received data packets. The processor 4 then selects one of a plurality of different bearer types 44 for communicating the data packets to the mobile communications device 4. In order to alert the mobile communications device 4 of the preferred radio access bearer, a communications device 46 within the radio bearer controller 40 generates a paging message 48 which includes a field 50 which identifies to the mobile communications device 4 that it should receive data packets. Furthermore the paging message 48 includes further fields 52 which specify in an order determined by the bearer controller 40 the preferred radio access interface to which the mobile communications device should attached in order to receive the data packets. Thus on receipt of the paging message 48, the mobile communications device 4 may convert from an IDLE to a CONNECTED state in order to “camp on” to abuse station providing a particular radio access bearer by performing an attach procedure to the radio network components or system concerned to access the radio bearer which is preferred by the radio bearer controller 40 for the mobile communications device to receive the data packets.

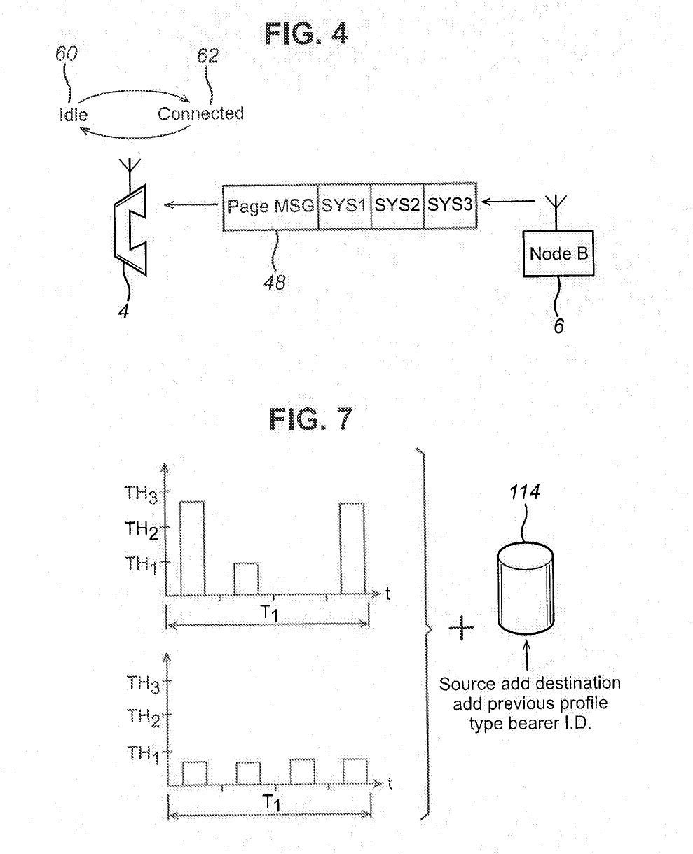

Thus as shown in FIG. 4 upon receipt of the paging message 48 from an eNodeB 6, the mobile communications device 4 converts from an IDLE state 60 to a CONNECTED state 62 in order to receive the data packets via a radio access interface which is indicated in the paging message 48. The eNodeB 6 is an example of a base station with which the mobile communications device 4 is currently attached but in an IDLE state in that only control-plane signalling is being communicated to or from the mobile communications device 4.

According to example embodiments the serving gateway therefore may perform one or more of the following operations:
Delay the triggering of paging in order to be able to assess traffic type.
Detect likely traffic type i.e. whether this is an isolated small packet, or regular periodic small packets or bursty transmission of high volume of data. This detection may be implemented by integrating data packets arriving in time T1 and checking this amount of data packets against the threshold value set
The aggregation time and the threshold value (TH1, TH2, TH3) might be varied by the operator to reflect parameters such as timers for transition to idle etc which depend on the target system and the type of the target system.
If the aggregated amount of data is less than the threshold value in time T1, the S-GW requests the MME and SGSN to page the mobile device with indication that the GPRS system shall be used as a default. Alternatively the system makes arrangements to use an LTE extension to facilitate efficient transmission of small packets
If the aggregated amount of data in time T1 is greater than the threshold value (TH1) then the system makes arrangement to send data over the UMT system or the LTE system. The latter system is used if second threshold (TH2) value is less than the aggregated data size with TH2>TH1.
It is possible to have several threshold values so that the suitable target system is selected or some optional system extensions are used.
Also periodicity of arrival can be taken into account in time T1 so that the system could adaptively vary IDLE←→ CONNECTED mode transition timers based on the properties of currently received traffic or historical data. This would be communicated also to the mobile device in the C-Plane signaling triggered by the S-GW and executed by either or both the SGSN or/and MME (e.g. in the NAS signaling)
Once the S-GW makes a decision on the target radio access system to be used, the mobile device is paged with the instruction to use the appropriate target system and to make a transition to the connected state from IDLE. If the mobile device is camped on the wrong system, the mobile device, based on the paging message content, will camp on the target system and initiate transition to the connected state in order to be able to receive the data.
If the S-GW detects that the traffic properties have changed and stay the same for some time the system can command the mobile device to make transition to IDLE and reconnect using the more suitable target system or initiate the handover procedure. Historical traffic parameters can also be taken into account when the decision is made and some prediction techniques based on profiling can also be used.

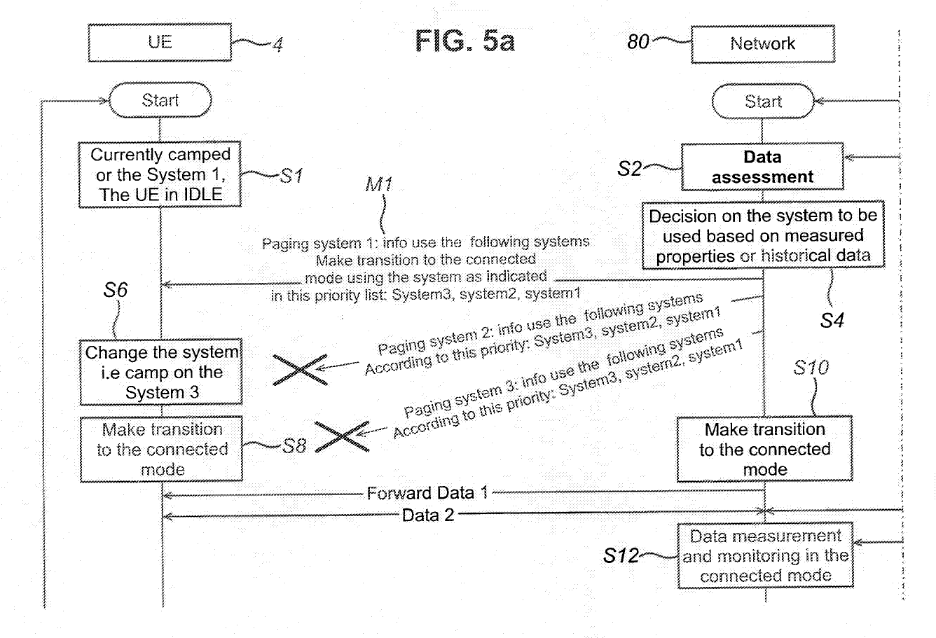

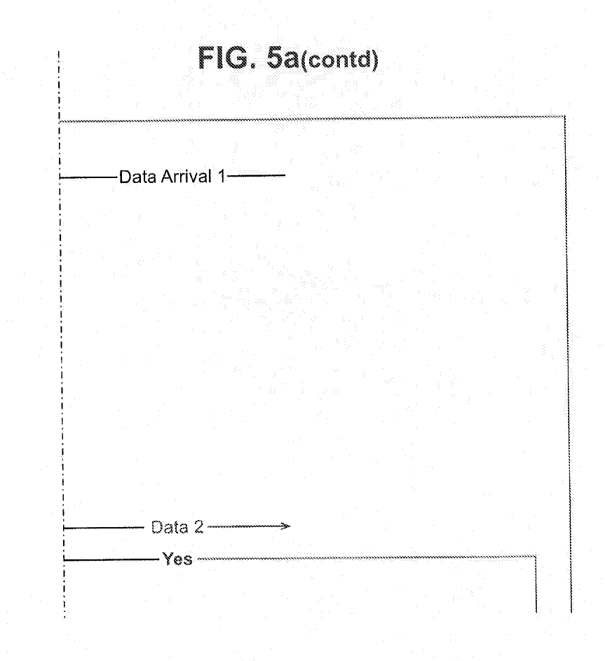

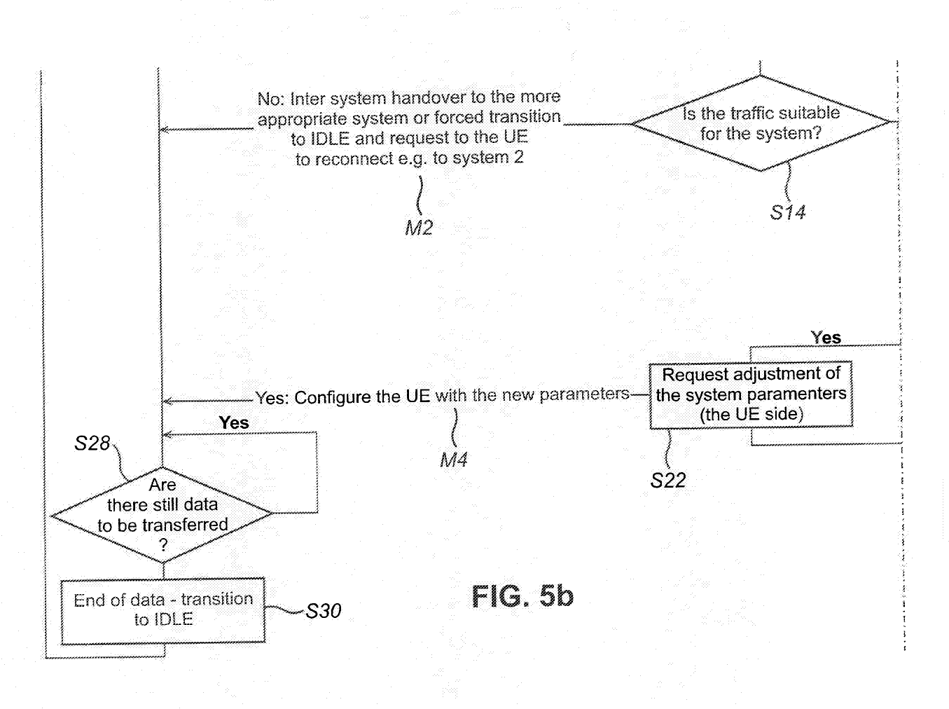

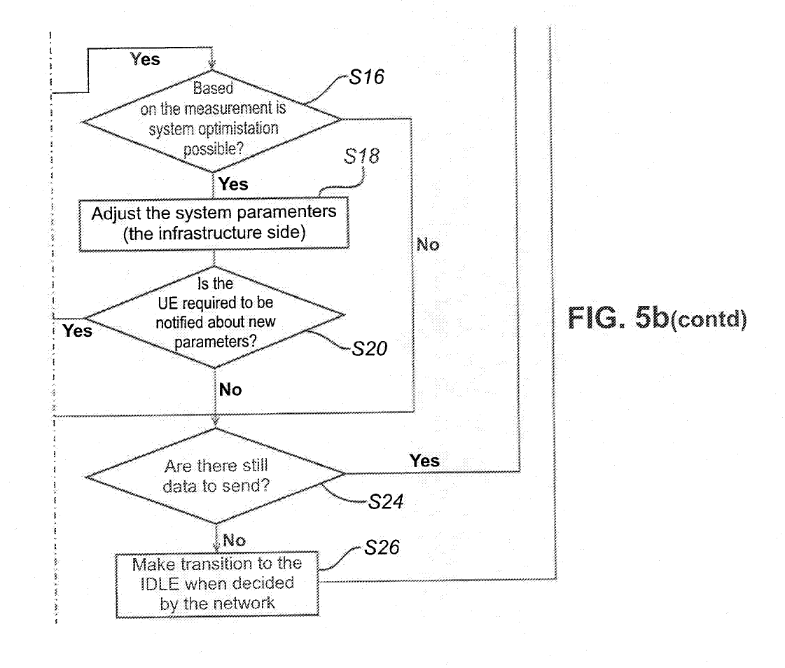

The operation of the mobile communications device 4 and the radio bearer controller 40 within the serving gateway is illustrated by the flow diagram formed by FIGS. 5a and 5b which will now be explained as follows:

S1: After the start of the process it is assumed that the mobile communications device 4 is currently attached to a radio access interface referred to as system 1.

S2: On the network side as shown in FIG. 5a data arrives for communication to the mobile communications device 4 which is then assessed by for example the bearer controller 40 to determine which of the radio access bearers would be most useful for communicating the data packets to the mobile communications device 4.

S4: As will be explained shortly the hearer controller 40 then makes a decision on the radio access system to be used to communicate the data packets based on measured properties of the packet data. A paging message M1 is then generated and communicated to the mobile communications device 4 which indicates in the paging message a list of preferred radio access bearers as for example shown in FIGS. 3 and 4. The paging message will be sent via the system to which the mobile communications device is currently attached namely system 1. The paging message M1 indicates a list of preferred radio access bearers for different systems, in this case system 3, system 2, system 1. If the bearer controller is not aware of the system to which the mobile communications device 4 is currently attached then paging messages are also sent via systems 2 and 3.

S6: The mobile communications device then changes attachment to system 3 being the preferred system to receive the data packets from the network. Then in steps 8 (S8) and step 10 (S10) both the mobile communications device 4 and the network make a transition to the connected mode. Accordingly the network is ready to communicate the data packets to the mobile communications device 4.

The network continues to communicate the data packets (data 2) to the mobile communications device 4.

S12: The bearer controller 40 is used to monitor the characteristics of the data packets being communicated to the mobile communications device after the mobile communications device 4 and the network 80 are in the connected mode.

S14: The bearer controller 40 then determines whether the traffic profile is suitable for the selected system. If the system is not suitable then the bearer controller directs the mobile communications device 4 via a message exchange M2 to perform an intersystem handover to the more appropriate system or a forced transition to the idle mode followed by a request to the mobile communications device to reconnect to a different system for example system 2.

S16: If the traffic pattern of the data packets is better suited to the radio access interface to which the mobile communications device is currently attached, then at step S16 the bearer controller determines whether any optimisation is possible for the current system.

S18: If optimisation is possible then the system parameters are adjusted from the infrastructure side.

S20: The bearer controller then determines whether the mobile communications device should be notified of the new parameters.

S22: If the new parameters are to be communicated to the mobile communications device then at step S22 the bearer controller requests adjustment of the system parameters on the side of the mobile communications device using a message exchange M4.

If no adjustment of the communications parameters is required then at step S24 the bearer controller 40 determines whether there is still more data to be sent. If there is data to be sent then the flow returns back to step S12. If there is no more data to be sent then the flow ends at step S26 which directs the mobile communications network to move to the idle state from the connected state. Similarly on the side of the mobile communications equipment 4 if there is no more data to be transferred then the flow moves to step S30 and the mobile communications device 4 enters the idle state.

### Identifying Traffic Profiles

According to some examples the bearer controller may be arranged to identify one out of a plurality of different traffic profiles by analysing the received data packets for a particular connection, that is for example a connection from a source addressed to a destination. Thus in accordance with the present technique the data packets received by the bearer controller for example the radio bearer controller 40 are analysed to identify a destination address. The destination address is therefore mapped to a particular connection to a mobile communications device 4. Thus having identified data packets destined for a particular mobile communications device 4 the bearer controller 40 may in one example buffer the data packets for a predetermined period of time T1. Within the predetermined period of time T1 a number of packets arriving within a predefined sub-interval are counted. The number of packets arriving within a predefined sub interval is then compared to corresponding thresholds. If the packets exceed a first threshold (TH1) but are less than a second threshold (TH2) then the bearer controller can confirm that within the sub interval, a particular rate of receipt of data packets corresponding to that threshold value, fanned between the thresholds, is present for the connection concerned. Correspondingly, where the number of packets exceeds a further threshold for example TH2 then the corresponding amount of data packets for that arrival rate can be identified.

By analysing the rate of arrival of data packets with respect to time within the predetermined time period T1, for each of a plurality of sub-intervals then a profile can be established for the communication of the data packets. By matching the profile with respect to one of a predetermined set of profiles, such as by counting the number of sub-intervals which are above a threshold value, and a time gap between the some level, then the bearer controller can identify the particular traffic profile with respect to one with a predetermined set of profiles from corresponding parameters values. The bearer controller can thereby identify the particular traffic profile for the connection.

In other examples the bearer controller monitors the rate of arrival of the data packets and compares a difference in time between a time of receipt of one data packet and another. A traffic profile can then be formed based on a mean arrival time of data packets and/or a standard deviation. Other statistical measures can be used such as a Poisson distribution arrival rate. By comparing the measured characteristics with predetermined characteristics for the traffic profile one of a predefined set of traffic profiles can be assigned to a particular connection and based on this traffic profile a bearer type can be selected.

### PDN Gateway Bearer Controller

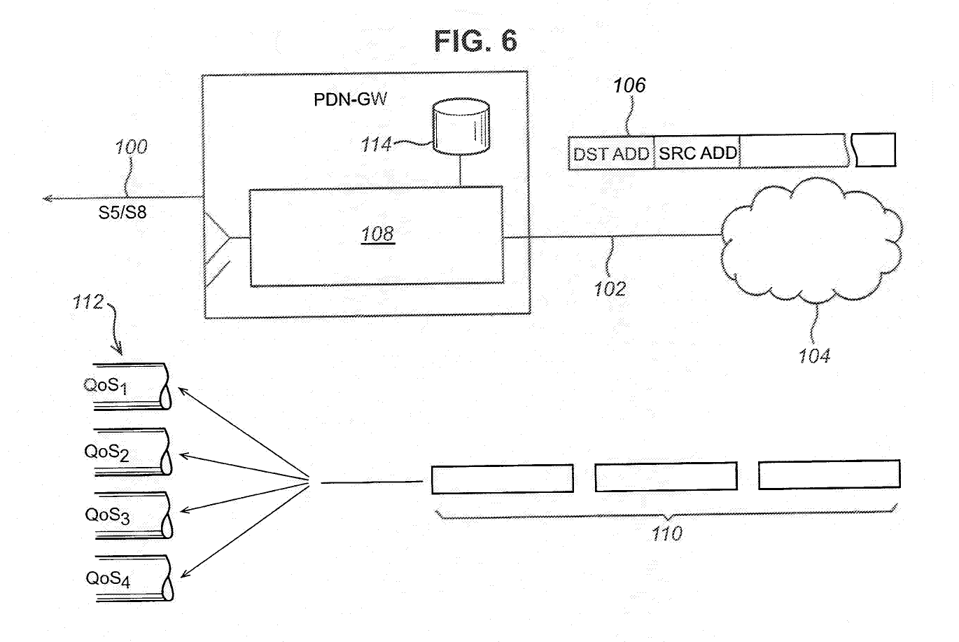

A similar arrangement for a bearer controller forming part of a PDN gateway 1 is shown in FIG. 6 and FIG. 7. As explained above a bearer controller according to an example embodiment may also form part of a PDN gateway 1 for selecting an appropriate communications bearer for communicating the data packets via an S5, S8 interface 100. As explained above data packets are received via an interface 102 from a packet data network 104. In one example the data packets are internet packets and so include a destination address, a source address as well as a payload data within an IP header 106.

In a similar way to the operation of the radio bearer controller 40 described above, a bearer controller 108 is arranged in operation to analyse data packets 110 which have been received from the PDN gateway via the interface 102 and to determine a particular profile of the data traffic. The bearer controller 108 then selects a bearer having a quality of service type which matches the particular profile of the traffic for the data packets destined for a particular mobile communications device from a particular source device. Thus as shown in FIG. 6 four different quality of service types QoS1, QoS2, QoS3, QoS4 forming four different communications bearers 112 are available for communicating the data packets. By selecting one of the communications bearers of the type which is best matched to the traffic profile for the data packets for a particular destination address the communication of the data packets can be arranged to make a most efficient use of available communications resources provided on the S5/S8 interface 100. This mapping is based on the following data extracted from protocol headers (source/destination IP address, source/destination port numbers, protocol type) as shown in FIG. 7 together with measuring the arrival rate of data packets as explained above and illustrated by the profiles 116. Some further static parameters can be use if deep packet inspection is used (DPI). Thus in accordance with this example embodiment the PDN-GW is arranged to detect traffic dynamically and to map the traffic type for a particular connection to a bearer providing a particular quality of serving. The mapping may take historical data into account, which may be stored in a data store 114, which can be used by the bearer controller to identify a most suitable bearer type, for example based on bearer id in the core network. By employing this technique at the PDN-GW the system could potentially use other technologies which are heterogeneous (non-3GPP) for example Wi-Fi, WiMAX, and use other types of wireless access interface, which use the PDN-GW as an aggregation point.

### Mobile Communications Device

Example embodiments which have been described above concern the communication of data packets from the network side to the mobile communications device 4. However, correspondingly embodiments of the present invention can also be applied when communicating data packets from the mobile communications device 4 to the mobile communications network, that is to say communication on the uplink. Similar traffic detection and discrimination techniques can be implemented at the mobile communications device based on the Traffic Flow Template TFT filters, which can include parameters such as Source/Dest IP addresses, Source/Dest port numbers, Protocol Id but conventionally do not take into account traffic shape. Each TFT is linked with a bearer. It is required that the traffic matching the TFT rule needs to be further discriminated and so the technique uses the analysis of packet data profiles as explained above. A bearer controller at the mobile device needs to decide whether the traffic matching the TFT rule will be mapped onto a suitable radio access system. A specific enhancement is to be used for example a dedicated bearer or shared bear in the LTE/EPS system, GPRS system etc.

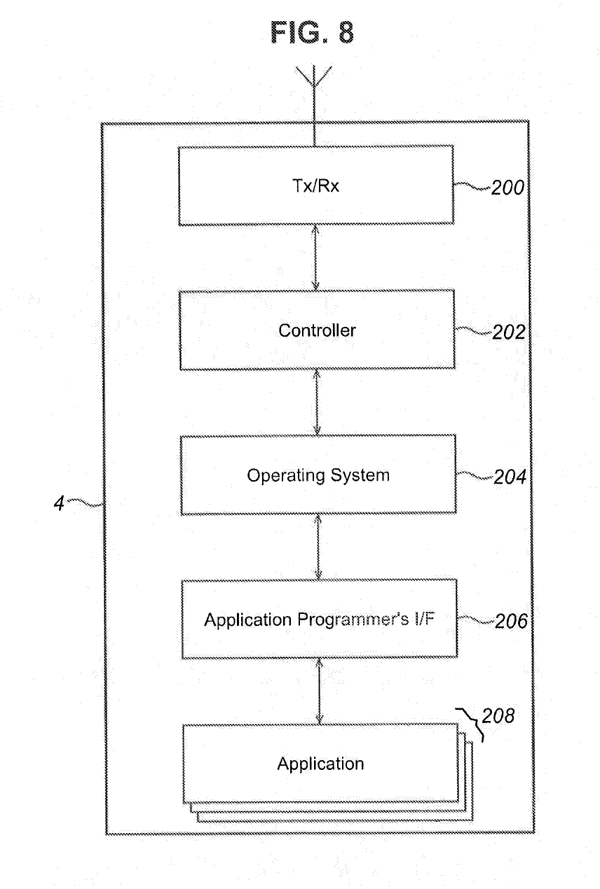

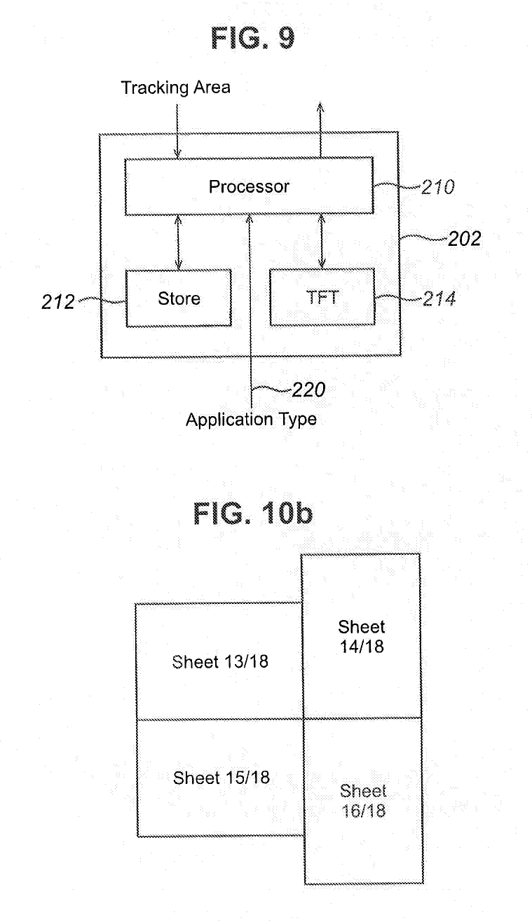

An example embodiment of the present invention when applied to communicating data packets from the mobile communications device to the mobile communications network on the uplink is shown in FIGS. 8 and 9. In FIG. 8 an example embodiment of a mobile communications device 4 is shown to include a transceiver unit 200 which is connected to a bearer controller 202. The mobile communications device 4 also includes an operating system 204 which interfaces with an application programmers interface 206 for executing one or more applications programs 208. The example mobile communications device shown in FIG. 8 corresponds substantially to a conventional device except for the presence of a bearer controller 202. As for the above examples, the bearer controller 202 controls the selection of a communication system with a wireless access interface for providing a radio access bearer of a type which most appropriately matches the traffic profile for the data packets to be communicated from for example an applications program 208 to a corresponding server via the mobile communications network. To this end, an example of the bearer controller 202 is showing in FIG. 9. In FIG. 9 the bearer controller 202 includes a processor 210 which utilises a data store 212 and also includes a traffic flow template (TFT) 214.

The processor 210 operates to control the bearer controller substantially as the bearer controller is explained for other example embodiments in that data packets to be communicated from the mobile communications device to the network are monitored to identify a traffic profile and in accordance with the traffic profile a radio access bearer type is selected which best matches the traffic profile. However in contrast to the embodiments shown above the bearer controller 202 may be provided with further information about the applications program 208 which is executing on a mobile communications device which can further characterise the traffic profile and therefore assist the selection of the most appropriate bearer for communicating the data packets. To this end, the bearer controller 202 receives an indication of the application type from the application programmer's interface 206 via the operating system 204 and as shown in FIG. 9 receives the application type via an interface 220. The application type can be used as additional information by the processor 210 in order to select the most appropriate radio access bearer for communicating the data packets. For example, if the application type indicates that the data packets are going to be generated sporadically for example as polling messages for an email type application Facebook or Twitter then the processor 210 may select a low capacity network and moreover one which may be adapted to support dedicated messaging.

As shown in FIG. 9 the bearer controller 202 is adapted to include a traffic flow template 214 which provides a set of control parameters and specification for the selection of a communications bearer at call setup. Furthermore once the connection has been established then the traffic flow template specifies parameters for the communication of data packets via a communications bearer. Thus the information provided in the traffic flow template 214 can be used by the processor 210 to select the most appropriate radio access bearer.

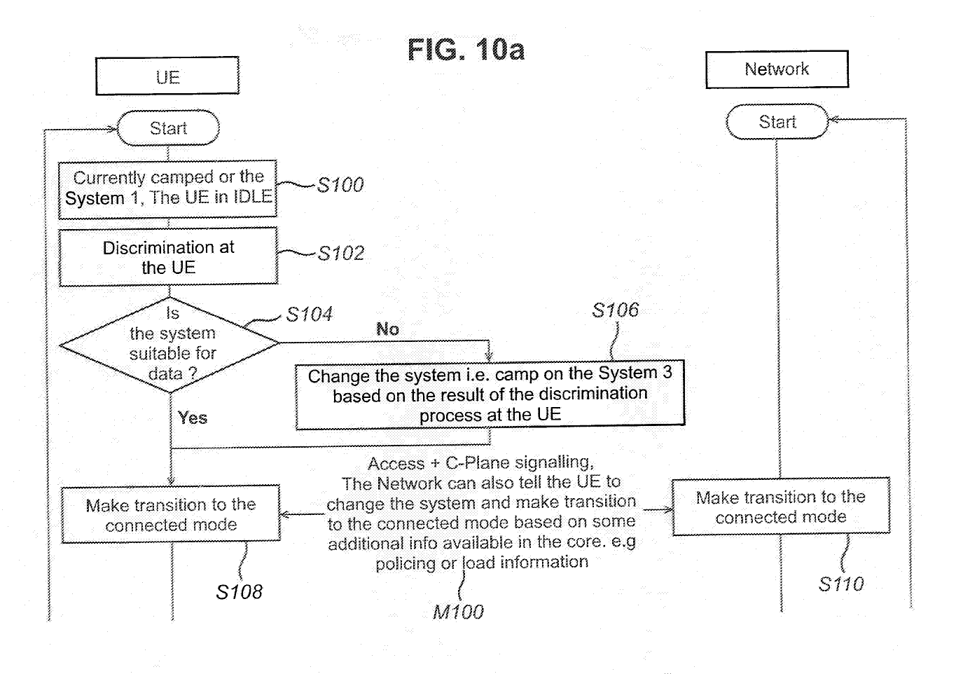

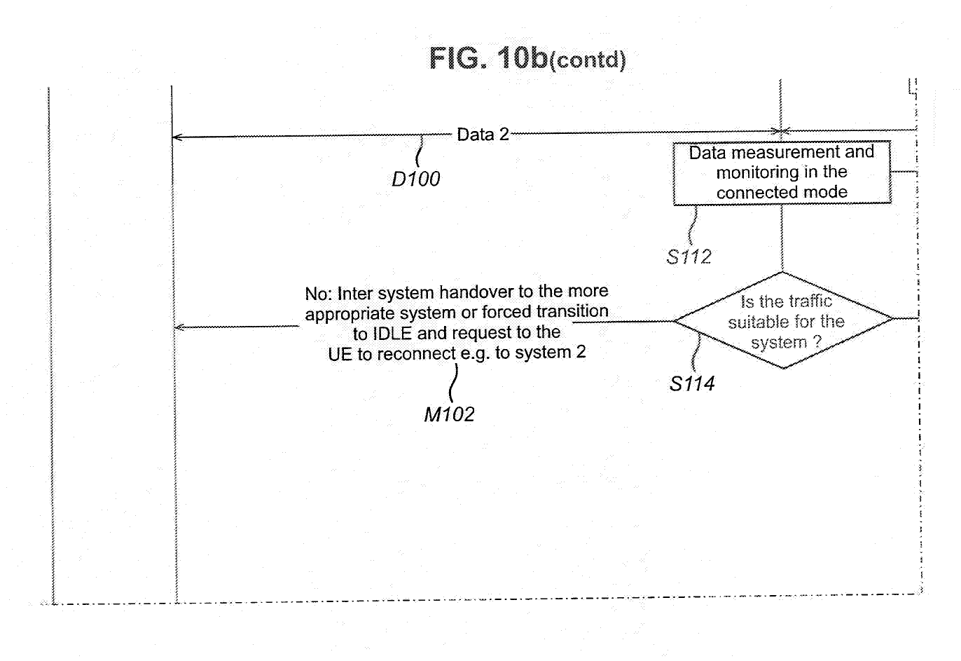

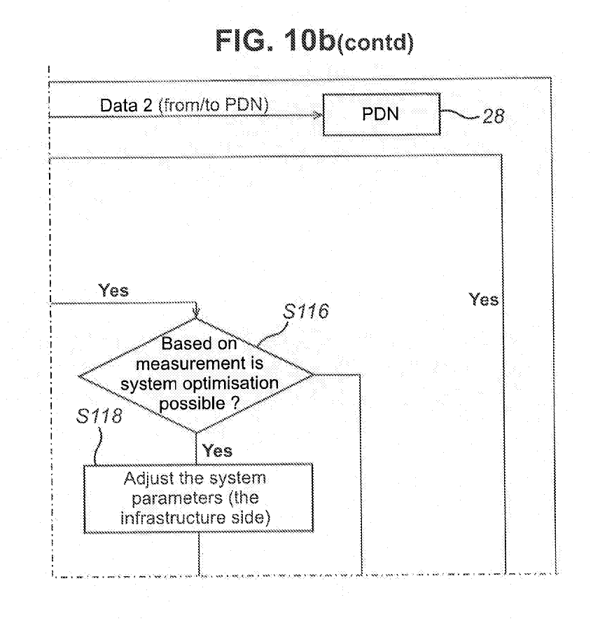

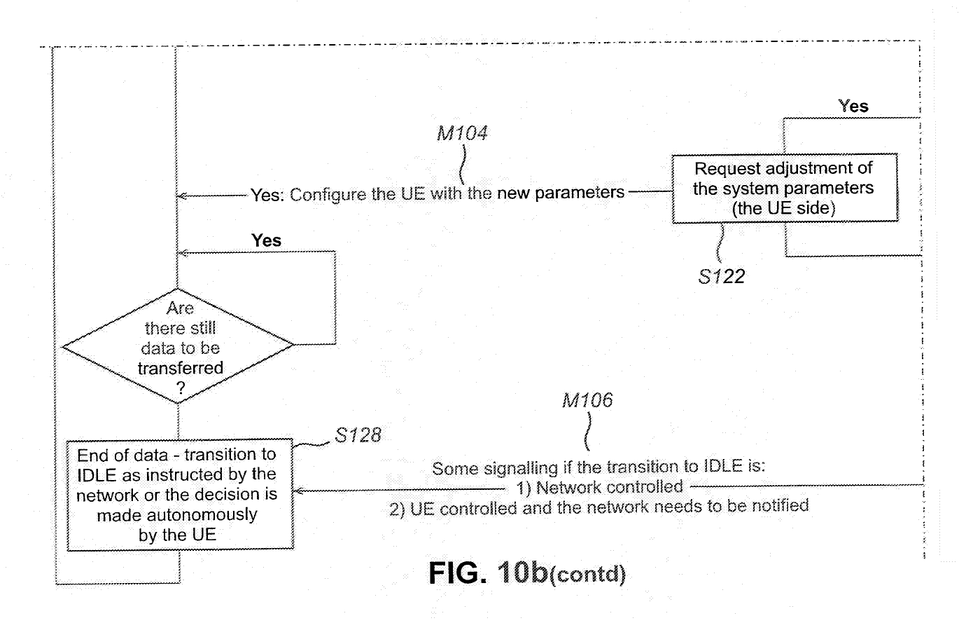

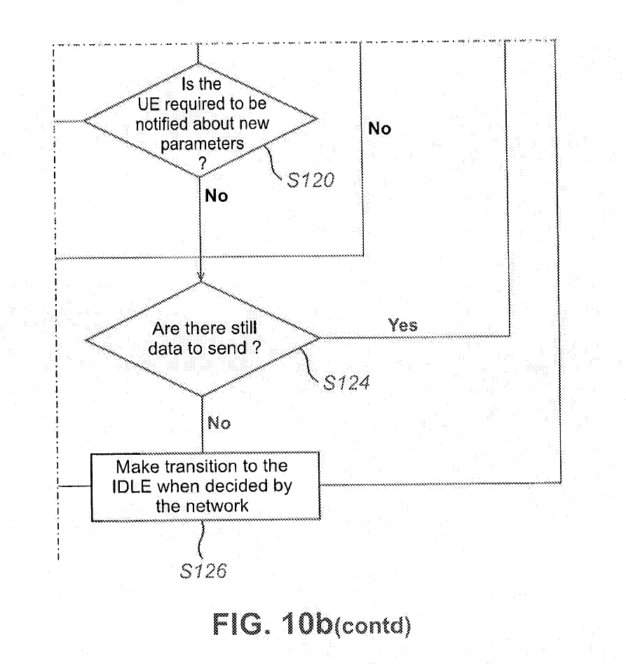

More detail of the operation of the mobile communications device and the network according to this example embodiment are presented in the flow diagram in FIGS. 10a and 10b is provided as follows:

S100: After the start of the process it is assumed that the mobile communications device 4 is already attached to a particular communications network. For example the mobile communications device 4 will be assumed to be in the idle state and currently attached to a system 1.

S102: In accordance with the present technique the bearer controller 202 is arranged to monitor the data packets which are generated by an application running on the mobile communications device 4 for communication to a particular destination address. After analysing the generation of the data packets the bearer controller 202 may identify that the generation of the packets corresponds to one of a predetermined set of traffic profiles or based on an analysis of the application for which the data packets are generated specifies that a particular radio access bearer should be used.

At step S104 the bearer controller 202 determines whether a radio access bearer which is currently available to the mobile communications device 4 when the mobile devices changes from an idle state into a connected state is suitable for the communication of the data packets to the destination address.

S106: If the radio access bearer currently available to the mobile communications device is not suitable in that a traffic profile or the application from which the data packets were generated are more suitably transmitted via a different radio access bearer then the bearer controller 202 controls the transceiver unit 200 to establish an attachment to a different radio access interface for example system 3. Optionally this may include performing registration and attachment procedures to the different radio access system.

S108: A mobile communications device then changes from an idle state to a connected state. To this end the mobile communications device 4 exchanges messages M100 with the mobile communications network which includes access and c plane signalling. In addition it is further envisage that the network at this point may direct the mobile communications device to change to a more suitable system.

S110: The mobile communications network also changes from an idle state to an active state for the connection to this mobile communications device 4. Once the mobile communications device and the network are in the connected state then data is communicated from the mobile communications device to the PDN in accordance with the conventional operation.

S112: Optionally a bearer controller within the mobile communications network monitors the data packets generated by the mobile communications device and receive for example at the serving gateway in order to establish whether the traffic generated by the mobile communications device is most appropriately handled by the current radio access network to which the mobile communications device is attached.

S114: A bearing controller within an infrastructure equipment of a mobile communications network then determines whether the traffic profile generated by the mobile communications device is most suitably handled by the radio access interface which is currently being used to communicate the data packets. If the current radio access interface is not the best one to use to communicate the data packets then by a message exchange M102 the mobile communications device is directed to perform an intersystem handover or forced to transition to an idle state and to request a reconnection to a different system for example system 2.

S116: A bearer controller within the mobile communications network is also directed to perform measurements to determine whether the radio access interface currently being used is the best one available for communicating the data packets.

S118: If the radio access interface is not being used optimally then the bearer controller or radio access interface is adjusted to change communications parameters on the infrastructure side.

S120: The bearer controller determines whether mobile communications device should be notified of the new system parameters and if it should be notified then at step S122 the bearer controller requests adjustment of the system parameters by communicating a message exchange M104 but otherwise processing proceeds to step S124 to determine whether there are still data packets to send. If yes then processing proceeds to step S112 to continue the monitoring of the traffic generated by the mobile communications device.

S126: if there are no more packets to send then the network transitions to an idle state and via message exchange M106 signalling is exchanged between the network and the mobile communications device to move the mobile communications device into the idle state as performed in step S128 on the mobile side.

For the above example the mobile communications device includes a bearer controller which is adapted to utilise other parameters in order to determine the most appropriate radio access bearer to use. As explained above embodiments can utilise a priori information such as which application generated the data packets. Such information can be available in the infrastructure nodes because the application type is implicitly linked with the QoS parameters allocated to the bearer. However there is no explicit information in the network about application types. The mobile device is able to access this information because the application layer resides in the mobile device as opposed to the network side where the application layer is terminated at the server located outside the network and controlled by the PLMN. Further modifications can be envisaged to make the traffic discrimination process more efficient:
The Application type is signaled to lower layers so the mobile device is able to make a better decision as to which system to be camped on and to be used.
The existing set of QoS parameters can be extended to include additional information such as:
   Is traffic delay tolerant
   Is application traffic expected to have properties of infrequent transmissions
   Is application expected to generate small packets

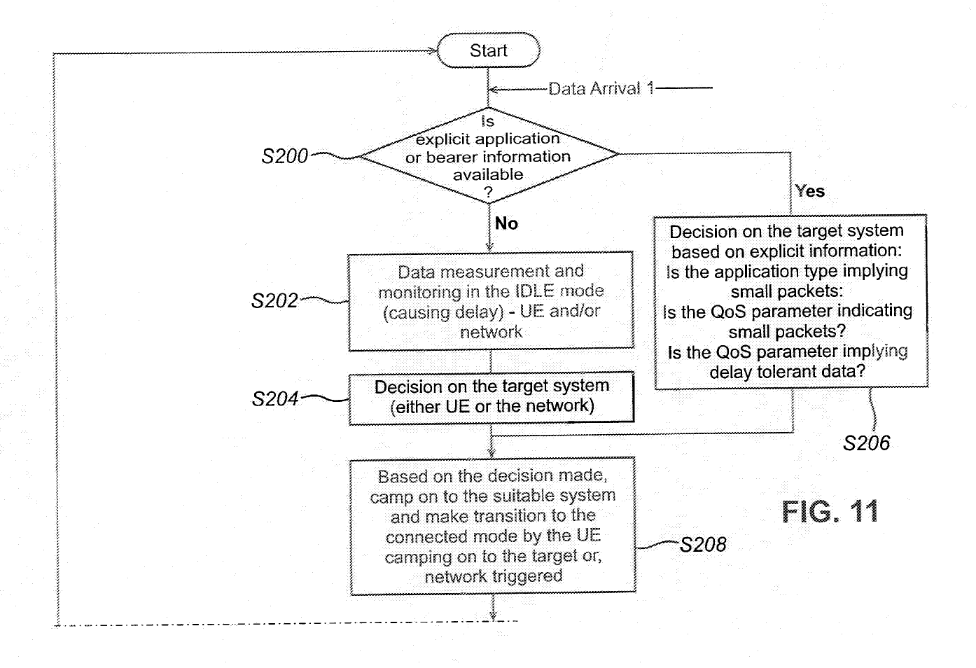

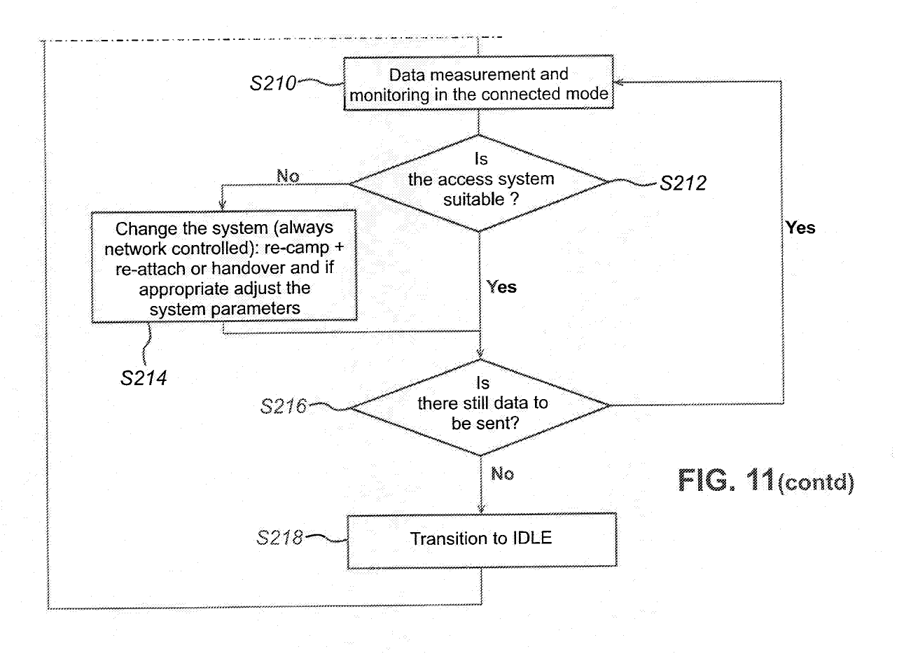

This information can be used to assist the network and mobile device to discriminate and make the decision as to which system is to be used. If additional bearer/application information is available the traffic discrimination process will typically take less time. An illustration of the operation of an example of a bearer controller in accordance with this example embodiment is provided in FIG. 11, which includes an enhanced process for determining whether the most appropriate radio access bearer is being used. The flow diagram is described as follows:

S200: After a start state the bearer controller 202 receives data packets for communication via the mobile communications network. The bearer controller 202 identifies the application which is being used to generate the data packets and/or identifies the destination address or the source address and determines whether application or bearer information is available as stored in a data store 212 of the bearer controller 202.

S202: If there is no application or bearer information available then the data packets generated by the application are monitored by buffing the data packets whilst the mobile communications device is in the idle mode to estimate a rate of generation of the data packets and/or other statistical measurements. The bearer controller within the mobile communications device then identifies a traffic profile which most appropriately characterises the generation of the data packets out of one of a predetermined set of data profiles.

S204: The bearer controller then determines the most appropriate target system or systems or generates an order of priority of radio access interfaces which are most suitable for the communication of the data packets.

S206: Application information or bearer information may be available to the bearer controller which either implies a type of packets which are being generated, a quality of service parameter which is required or the size of the packets being generated for communication. The bearer controller may then decide on a suitable preferred radio access interface based on the information which is available including the application type or the bearer information which is specified and/or information which has been pre-stored for a previous connection within the data store.

S208: Based on a decision from the bearer controller the mobile communications device, is directed to camp on to or attach to the preferred radio access interface/system and transition to the connected mode. The mobile communications device may be arranged to camp on to or attach to the new system by either:
The mobile communications device, performing the active steps of camping onto the target system, which may optionally include registering with the new system, if the mobile device has not yet registered with the new system, and then making a transition to the connected mode either triggered by the mobile device or by responding to paging; or
The new system paging where the mobile device is directed which system to re-camp on (also attach if required) and make a transition to the connected mode.

S210: A measurement of the generated data packets then continues within a predetermined period.

S212: The bearer controller continues to monitor the data packets and to determine a suitable traffic profile for the data packets. The bearer controller then assesses whether the current radio access interface is via the most appropriate radio access bearer for communicating the data packets.

S214: If the current radio access interface is not the most suitable for providing a radio access bearer for communicating the data packets then the mobile communications device is directed to perform a handover to a preferred target system or instructed to reattach or make an adjustment of system parameters.

S216: At step S216 the bearer controller determines whether there are still data packets to be sent. If yes then processing proceeds to step 210. Otherwise, processing proceeds to step 218 and the mobile communications device changes from the connected state to the idle state. Processing then loops back to the start state.

Various further aspects and features of the present invention are defined in the appended claims. Various modifications may be made to the embodiments described above without departing from the scope of the present invention. For example, embodiments of the present invention find application with other types of mobile communications networks and is not limited to LTE. Furthermore embodiments can be arranged to make a decision as to which bearer should be used for data delivery for mobile devices in the IDLE as well as connected modes, system timers may be variable and adjusted in relation to some properties of traffic and paging messages may be provided with an indication of the system the mobile device should choose to receive data.

What is claimed is:

1. A mobile communications device configured
to communicate data packets via a mobile communications network, the mobile communications network including a radio network part which includes a plurality of base stations providing a plurality of different radio access interfaces from which a plurality of different radio access bearer types can be formed for communicating the data packets from the mobile communications devices, and a core network part which includes a plurality of infrastructure equipment for communicating the data packets from the radio network part, the mobile communications device including
a radio bearer controller which is configured
to determine a traffic profile of the data packets to be communicated via the mobile communications network from one of a predetermined set of possible traffic profiles, and
to select one of the plurality of different radio access types to provide a radio access bearer of a type most suitable for communicating the data packets from the mobile communications device in accordance with the determined traffic profile of the data packets.

2. The mobile communications device of claim 1, wherein the mobile communications device is in an idle state in which the mobile communications device is not communicating data packets via the mobile communications network using a radio communications bearer, and the radio bearer controller is configured
after determining the traffic profile of the data packets to be communicated, to attach to the selected radio access interface,
to establish a radio communications bearer for communicating the data packets via the established radio access bearer of the selected radio access interface type, and
to move thereby to a connected state.

3. The mobile communications device of claim 2, wherein the mobile communications device is configured, when the mobile communications device is not yet attached to the selected radio access interface,
to register with the selected radio access interface, and/or
to attach to the selected radio access interface.

4. The mobile communications device of claim 1, wherein the radio bearer controller is configured to determine the traffic profile type by
observing a relative rate of receiving the data packets with respect to time,
comparing the relative rate of receiving the data packets with a predetermined set of relative rates, and
determining the traffic profile by matching the observed relative rate of receiving the data packets with a corresponding predetermined relative rate for the traffic profile.

5. The mobile communications device of claim 4, wherein each of the predetermined set of relative rates corresponds to a threshold value of a number of data packets which may be received within a predetermined period of time and the determining the relative rate of receiving data packets comprises
buffering the data packets for communication to the mobile communications device for the predetermined time period,
determining a number of data packets which are received within the predetermined period, and
comparing the number of data packets received within the predetermined period with one of the predetermined set of thresholds to provide an indication of the relative rate of receiving data within the predetermined time period.

6. The mobile communications device of claim 5, wherein the predetermined time period is variable.

7. The mobile communications device of claim 1, wherein the data packets include internet packets having a source address, a destination address and a port number and the traffic profile is determined by
mapping at least one of the port number, the source address or the destination address to one of the predetermined profile types stored in a data store.

8. The mobile communications device of claim 7, wherein the mapping includes performing a reverse domain name server query on the source address.

9. The mobile communications device of claim 7, wherein the bearer controller includes a data store for storing a previously determined traffic profile type with respect to and indication of a logical connection via which the data packets are communicated to the mobile communications device.

10. The mobile communications device of claim 9, wherein the indication of the logical connection includes at least one of a unique index, a source address, a destination address or an international mobile subscriber identity number.

11. The mobile communications device of claim 10, wherein the bearer controller is configured to determine the traffic profile type based on a type of an application program which has generated the data packets.

12. The mobile communications device of claim 1, wherein the traffic profile type is determined when the mobile communications device is in a connected state in which a communications bearer has been established for communicating the data packets to and or from the mobile communications network, and the traffic profile type is determined by monitoring the data packets being communicated and determining the traffic profile type based upon the data packets communicated via the communications bearer.

13. A method of communicating data packets from a mobile communications device via a mobile communications network, the mobile communications network including a radio network part which includes a plurality of base stations providing a plurality of different radio access interfaces from which a plurality of different radio access bearer types can be formed for communicating the data packets from the mobile communications devices, and a core network part which includes a plurality of infrastructure equipment for communicating the data packets from the radio network part, the method comprising
determining a traffic profile of the data packets to be communicated via the mobile communications network from one of a predetermined set of possible traffic profiles, and
selecting one of the plurality of different radio access interfaces to provide a radio access bearer of a type suitable for communicating the data from the mobile communications device in accordance with the determined traffic profile of the data packets.

14. The method of claim 13, the method comprising
setting the mobile communications device is in an idle state in which the mobile communications device is not communicating data packets via the mobile communications network using a radio communications bearer, and
after determining the traffic profile of the data packets to be communicated, attaching to the selected radio access interface,
establishing a radio communications bearer for communicating the data packets via the established radio access bearer of the selected radio access interface type, and
moving thereby to a connected state.

15. The method of claim 14, the method comprising if the mobile communications device is not yet attached to the selected radio access interface,
registering with the selected radio access interface, or
attaching to the selected radio access interface.

16. The method of claim 13, wherein the determining the traffic profile of the data packets to be communicated includes
observing a relative rate of receiving the data packets with respect to time,
comparing the relative rate of receiving the data packets with a predetermined set of relative rates, and
determining the traffic profile by matching the observed relative rate of receiving the data packets with a corresponding predetermined relative rate for the traffic profile.

17. The method of claim 16, wherein each of the predetermined set of relative rates corresponds to a threshold value of a number of data packets which may be received within a predetermined period of time and the determining the relative rate of receiving data packets comprises
buffering the data packets for communication to the mobile communications device for the predetermined time period,
determining a number of data packets which are received within the predetermined period, and
comparing the number of data packets received within the predetermined period with one of the predetermined set of thresholds to provide an indication of the relative rate of receiving data within the predetermined time period.

18. The method of claim 17, wherein the predetermined time period is variable.

19. The method of claim 13, wherein the data packets include internet packets having a source address, a destination address and a port number and the traffic profile is determined by
mapping at least one of the port number, the source address or the destination address to one of the predetermined profile types stored in a data store.

20. The method of claim 19, wherein the mapping includes performing a reverse domain name server query on the source address.

21. The method of claim 19, the method comprising
storing a previously determined traffic profile type in a data store with respect to an indication of a logical connection via which the data packets are communicated to the mobile communications device.

22. The method of claim 21, wherein the indication of the logical connection includes at least one of a unique index, a source address, a destination address or an international mobile subscriber identity number.

23. The method of claim 22, wherein the determining the traffic profile of the data packets to be communicated includes
determining the traffic profile type based on a type of an application program which has generated the data packets.

24. The method of claim 23, wherein the determining the traffic profile type includes determining the traffic profile based on a type of an application program which has generated the data packets.

25. The method of claim 13, wherein the determining the traffic profile type of the data packets to be communicated comprises
determining the traffic profile type, when the mobile communications device is in a connected state in which a communications bearer has been established for communicating the data packets to and or from the mobile communications network, and the determining the traffic profile type being based upon the data packets communicated via the communications bearer.
